(19) United States
(12) Patent Application Publication
(10) Pub. No.: US 2024/0223659 A1
(43) Pub. Date: Jul. 4, 2024

(54) EDGE DEVICE

(71) Applicant: TRIPODWORKS CO., LTD., Sendai-shi, Miyagi (JP)

(72) Inventors: Fumihiko SUGIYAMA, Sendai-shi, Miyagi (JP); Itaru YAMAGUCHI, Sendai-shi, Miyagi (JP); Kazuyoshi ENDO, Sendai-shi, Miyagi (JP); Norio OBA, Sendai-shi, Miyagi (JP)

(73) Assignee: TRIPODWORKS CO., LTD., Sendai-shi, Miyagi (JP)

(21) Appl. No.: 18/563,205

(22) PCT Filed: Dec. 15, 2022
(86) PCT No.: PCT/JP2022/046140

§ 371 Date: Nov. 21, 2023

(30) Foreign Application Priority Data
Jan. 28, 2022 (JP) 2022-012201

(51) Int. Cl. H04L 67/12

(52) U.S. Cl. CPC H04L 67/12

(57) ABSTRACT

An edge device 1 includes a sensing information reception unit 3 that receives sensing information from one or a plurality of sensors; a user identification information storage unit 5 that stores identification information pertaining to a user who uses the sensing information; a user identification information addition unit 7 that obtains user-specific sensing information obtained by adding, to the sensing information, the identification information of the user who uses the sensing information; and a sensing information transmission unit 9 for transmitting the user-specific sensing information to an edge server.

### TECHNICAL FIELD

The present invention relates to an edge device that can utilize and process sensing information, and a system or the like that includes such an edge device.

### BACKGROUND ART

JP 2018-195175 A describes an edge computing system. This system includes an edge device connected to one or more sensors and an edge server (claim 1). This system appropriately controls data communication between the edge device and the edge server, achieving both real-time performance and storage of all data.

In this system, the edge device is intended only to transmit data from a sensor to the edge server.

### CITATION LIST

### Patent Literature

Patent Literature 1: JP 2018-195175 A

### SUMMARY OF THE INVENTION

### Technical Problem

An object according to the present disclosure is to provide an edge device that can effectively utilize sensing data, a system or the like including such an edge device.

### Solution to Problem

Basically, the above problem is based on knowledge that an amount of transmission can be reduced by the edge device sending not only sensing information to a server, but also sending sensing information to an appropriate edge server for each user that requires the sensing information. The above problem can be solved by further performing a computation process for each user using the sensing information as appropriate, and then transmitting the sensing information with user information added to a server.

One of the inventions described in this specification relates to an edge device 1.

This edge device 1 includes a sensing information reception unit 3, a user identification information storage unit 5, a user identification information addition unit 7, and a sensing information transmission unit 9.

The sensing information reception unit 3 is an element for receiving sensing information from one or more sensors.

The user identification information storage unit 5 is an element for storing identification information of a user that uses sensing information.

The user identification information addition unit 7 is an element for obtaining user specific sensing information. The user specific sensing information is information obtained by adding identification information of a user that uses the sensing information read from the user identification information storage unit 5 to the sensing information.

The sensing information transmission unit 9 is an element for transmitting user specific sensing information to an edge server.

This edge device adds identification information of the user that requires sensing information to the sensing information, and thus the edge device can perform a computation process for each user. In addition, sensing information may be sent to an appropriate server for each user.

A preferred form of this edge device 1 further includes a programmable computation storage unit 11 and a computation processing unit 13.

The programmable computation storage unit 11 is an element for programmably storing a computation process to be performed on sensing information.

The computation processing unit 13 is an element for performing a computation process that is stored in the programmable computation storage unit 11 on the sensing information.

In this form, the sensing information transmission unit 9 transmits user specific sensing information after computation to the edge server, the user specific sensing information after computation is sensing information that has been subjected to a computation process by the computation processing unit 13, and the user specific sensing information after computation is information to which identification information of the user that uses the information is added.

The edge device of this form performs a computation process on the sensing information on the edge device side, and thus it is possible to reduce the amount of communication and perform necessary processing in advance. In a case where necessary information is missing, the information may be sent to the server after the necessary information is gathered. In addition, the computation contents are programmable, and thus the computation contents for the sensing information may be modified as appropriate.

In a preferred form of this edge device 1, the programmable computation storage unit 11 stores a computation process for each user, the computation process being related to the identification information of the user: and the computation processing unit 13 performs the computation process for each user on sensing information. In this form, different computation can be performed on sensing information for each user.

In a preferred form of this edge device 1, the sensing information is information received from a plurality of sensors, the programmable computation storage unit 11 stores a computation process for each sensor, the computation processes corresponding to each of the plurality of sensors, and the computation processing unit 13 performs the computation process for each sensor on the sensing information. This form allows for different computations to be performed for each sensor.

In a preferred form of this edge device 1, the sensing information transmission unit 9 transmits user specific sensing information after computation to a specific edge server among a plurality of edge servers using the identification information of the user.

A preferred form of this edge device 1 further includes an alert condition storage unit 15 and an alert output unit 17.

The alert condition storage unit 15 is an element for storing alert conditions, which are conditions for issuing an alert.

The alert output unit 17 is an element for outputting an alert in a case where the sensing information satisfies an alert condition.

The edge device may be, for example, a device connected to an in-vehicle sensor that can send an alert to a driver when the device detects danger.

A preferred form of using the edge device 1 relates to an edge computing system. The edge computing system includes any of the edge devices 1 described above and an edge server 21 that can exchange information with the edge device 1.

One of the inventions described in this specification relates to an information processing method using the edge device 1. This method preferably uses any of the edge devices 1 described above.

This method includes a sensing information reception step, a user identification information addition step, and a sensing information transmission step.

The sensing information reception step is a step in which the edge device 1 receives sensing information from one or a plurality of sensors.

The user identification information addition step is a step of obtaining user specific sensing information by the edge device 1 adding identification information of a user that uses sensing information to the sensing information.

The sensing information transmission step is a step in which the edge device 1 transmits user specific sensing information to the edge server.

One of the inventions described in this specification relates to a program for causing the edge device 1 including a computer to function as any of the edge devices described above. In addition, another form of the program is a program for enabling the edge device 1 including a computer to implement the information processing method using the edge device 1 described above.

One of the inventions described in this specification relates to a computer readable information recording medium on which the above program is recorded.

### Effect of Invention

The technique according to the present specification is able to provide an edge device that can effectively utilize sensing data, and a system and the like including such an edge device.

### BRIEF DESCRIPTION OF THE DRAWINGS

FIG. 1 is a block diagram of an edge device.

FIG. 2 is a block diagram of an edge computing system.

FIG. 3 is a flowchart for explaining an example of an information processing method using an edge device.

### DETAILED DESCRIPTION OF THE INVENTION

Hereinafter, embodiments of the invention will be described using the drawings. The present invention is not limited to the embodiments described below, and also includes modifications made from the following embodiments as appropriate within a range obvious to one skilled in the art.

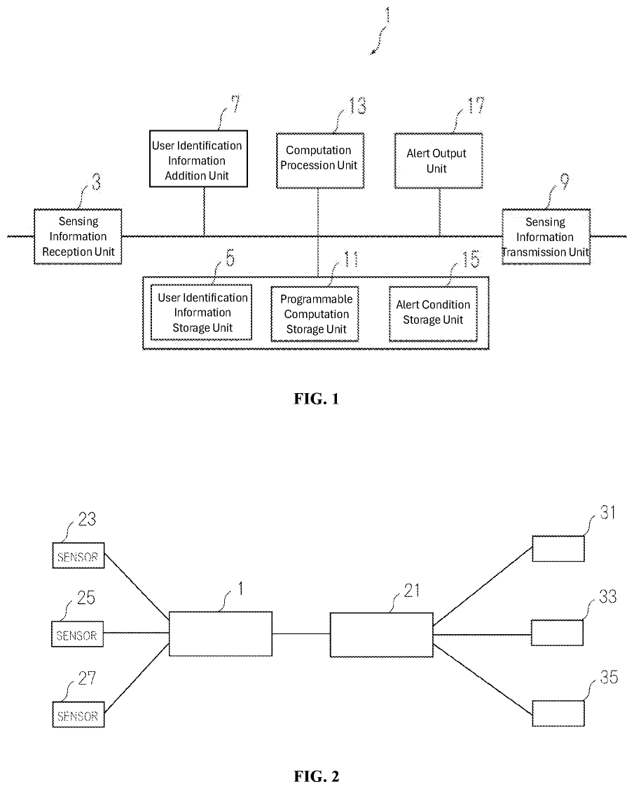

FIG. 1 is a block diagram of an edge device. As illustrated in FIG. 1, this edge device 1 includes a sensing information reception unit 3, a user identification information storage unit 5, a user identification information addition unit 7, and a sensing information transmission unit 9. In addition, this edge device 1 may further include any one or more elements among a programmable computation storage unit 11, a computation processing unit 13, an alert condition storage unit 15, and an alert output unit 17.

### Edge Device 1

The edge device 1 is an information communication element used in an IoT system, for example. The edge device 1 is configured to be able to receive information from a sensor that acquires sensing data, and acquire sensing information from one or more sensors. The edge device 1 transmits sensing information to an edge server 21. The edge server 21 further transfers sensing information to a cloud server or the like. The edge device 1 is a communication device including a computer (or processor).

The computer (or processor) has an input unit, an output unit, a control unit, a computation unit, and a storage unit, and each element is connected by a bus or the like so that information can be exchanged. For example, the storage unit may store a control program or various information. In a case where predetermined information is input from the input unit, the control unit reads the control program stored in the storage unit. The control section then reads information stored in the storage unit as appropriate and transmits the information to the computation unit. Further, the control unit transmits appropriately input information to the computation unit. The computation unit performs computation processing using the received various information and stores the computation result in the storage unit. The control unit reads the computation result stored in the storage unit and outputs the computation result from the output unit. In this way, various processes and steps are executed. The means and units execute these various processes. Note that the method described in this specification may be implemented by the steps executed by the elements.

### Sensing Information Reception Unit 3

The sensing information reception unit 3 is an element for receiving sensing information from one or more sensors. For example, the input unit (sensor interface I/F) functions as the sensing information reception unit 3. When the sensor is activated, sensing information measured by the sensor is input to the edge device 1 via the sensing information reception unit 3. The edge device 1 receives sensing information in this way. Any known sensor may be used as the sensor as appropriate. The sensor is a device for measuring some physical quantity. Examples of sensors include temperature sensors, photodetectors, calorimetric sensors, strain gauges, and acceleration sensors.

### User Identification Information Storage Unit 5

The user identification information storage unit 5 is an element for storing identification information of a user that uses sensing information. For example, the storage unit functions as the user identification information storage unit 5. The storage unit in this case may be a temporary storage unit (RAM or the like) or a semi-permanent storage unit (hard disk or the like). The user may be a user (computer, terminal, or the like) that uses sensing information.

### User Identification Information Addition Unit 7

The user identification information addition unit 7 is an element for obtaining user specific sensing information. For example, the input unit, computation unit, control unit, and storage unit function as the user identification information addition unit 7. The user specific sensing information is information obtained by adding identification information of a user that uses the sensing information read from the user identification information storage unit 5 to the sensing information. For example, the storage unit of an edge device stores identification information of required sensing information (for example, identification information of a required sensor, or type of required sensing information) in association with user identification information. An edge device receives sensing information from a certain sensor as well as identification information of that sensor. Then, the edge device uses the identification information of the sensor to read the identification information of the user that requires the sensing information from the storage unit. In addition, the edge device associates the identification information of the user that uses the sensing information with the sensing information, and stores the result in the storage unit. In this way, the edge device is able to obtain user specific sensing information.

### Sensing Information Transmission Unit 9

The sensing information transmission unit 9 is an element for transmitting user specific sensing information to the edge server 21. For example, the output unit (communication I/F) functions as the sensing information transmission unit 9. The sensing information transmission unit 9 transmits user specific sensing information to the edge server 21. The edge server then acquires user specific sensing information. At this time, the user specific sensing information may be sent to an appropriate edge server 21 based on the user information. Particularly, in a case where there are multiple edge servers 21 corresponding to the edge device 1, the amount of transmission can be reduced by sending user specific sensing information only to a specific edge server 21. In this case, it is only necessary that information regarding the edge server 21 that transmits the user specific sensing information is stored in the storage unit in association with the user information. Moreover, the user specific sensing information may be transmitted from the edge server 21 only to an appropriate cloud server. The storage unit stores necessary sensing information and computation processing information related to the identification information of the user, as well as information related to the transmission destination edge server to which user specific sensing information after computation is sent, and information related to a specific cloud server. Using this information, the system transmits user specific sensing information after computation to a specific edge server. In addition, the system may transmit information related to a specific cloud server together with the user specific sensing information after computation to the edge server. The edge server that receives this information transmits the user specific sensing information after computation to a specific cloud server.

### Programmable Computation Storage Unit 11

The programmable computation storage unit 11 is an element for programmably storing a computation process to be performed on sensing information. For example, the input unit and the storage unit function as the programmable computation storage unit 11. For example, the edge device is designed so that the control program can be rewritten as appropriate. Therefore, the contents of the computation process can be rewritten by inputting information via the interface (I/F). In addition, for example, the edge device may have a connection portion with an external memory, such as a USB connection portion. In this case, the control program stored in the storage unit may be updated by connecting an external memory.

The programmable computation storage unit 11 may store a computation process for each user, the computation process being related to identification information of the user. For example, when programming the computation process, contents of a computation process related to the identification information of the user is input. Then, the programmable computation storage unit 11 stores the computation process contents related to the identification information of the user.

The programmable computation storage unit 11 may store a computation process for each sensor as computation processes corresponding to each of a plurality of sensors. The programmable computation storage unit 11 may store a different encryption method for each user, and perform an encryption process using an encryption method related to user information related to sensing information. In addition, the programmable computation storage unit 11 may store an encryption method related to a communication band, and may encrypt the sensing information based on communication band information when a transmission unit transmits the sensing information.

### Computation Processing Unit 13

The computation processing unit 13 is an element for performing a computation process that is stored in the programmable computation storage unit 11 on the sensing information. For example, the control unit, the storage unit, and the computation unit function as the computation processing unit 13. The sensing information is stored in the storage unit, for example. The control unit, according to commands of the control program stored in the programmable computation storage unit 11, reads the sensing information and causes the computation unit to perform a computation process. In this way, the computation processing unit 13 performs the computation process stored in the programmable computation storage unit 11 on the sensing information. In this way, the edge device performs an appropriate computation process and transmits the sensing information to the edge server, making it possible to reduce unnecessary information and the amount of communication. In addition, information can be sent only to an appropriate edge server.

### Alert Condition Storage Unit 15

The alert condition storage unit 15 is an element for storing alert conditions, which are conditions for issuing an alert. An alert is, for example, a warning in a situation where sensing information becomes meaningless or in an emergency. For example, the storage unit functions as the alert condition storage unit 15. However, whether or not to output an alert is also a type of programmable computation, and thus the programmable computation storage unit 11 may also function as the alert condition storage unit 15. Examples of alert conditions include a carbon dioxide concentration being a predetermined value, a carbon monoxide concentration being a predetermined value, a vehicle interior temperature being a predetermined value, and a distance between a monitor and the head being a predetermined value.

### Alert Output Unit 17

The alert output unit 17 is an element for outputting an alert in a case where the sensing information satisfies an alert condition. For example, the control unit, the computation unit, the storage unit, and the output unit function as the alert output unit 17. Examples of alerts include audio or light warnings. Specific examples of the output unit include speakers, monitors, and I/Fs.

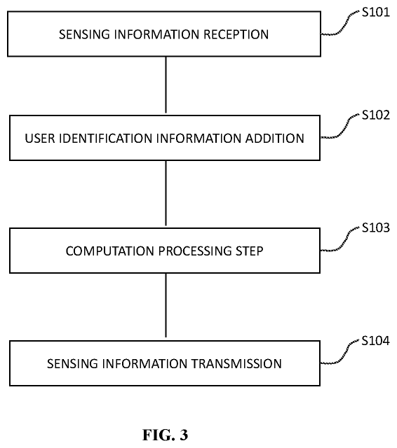

FIG. 2 is a block diagram of the edge computing system. As illustrated in FIG. 2, an edge computing system 23 includes any of the edge devices 1 described above and the edge server 21 that is able to exchange information with the edge device 1. The edge device is usually connected to a plurality of sensors 23, 25, 27. The edge server 21 may further be connected to servers such as cloud servers 31, 33, and 35. In this way, for example, an IoT server is constructed. The connection may be a physical connection: however, as long as information may be exchanged, the connection does not need to be a physical connection. For example, the edge device 1 and the edge server 21 may be physically connectable or may be physically separated. In a case where the edge device 1 and the edge server 21 can be physically connected, it is preferable that the edge device 1 and the edge server 21 be able to be attached and detached via a connecting portion.

### Program

One of the inventions described in this specification relates to a program for causing the edge device 1 including a computer (or a processor) to function as any of the edge devices described above. A program according to another aspect is a program for enabling the edge device 1 including a computer (or a processor) to implement the information processing method using the edge device 1 described above.

### Information Recording Medium

One of the inventions described in this specification relates to a computer readable information recording medium on which the above program is recorded. Examples of an information recording medium include CDs, CD-ROMs, DVDs, SD cards, memory chips, USB memories, and hard disks.

FIG. 3 is a flowchart for explaining an information processing method using an edge device. In this example, the information processing method using an edge device includes a sensing information reception step (S101), a user identification information addition step (S102), a computation processing step (S103), and a sensing information transmission step (S104). The steps may be the above-mentioned steps.

### Examples

An example of information processing using an edge device will be explained below. In this example, the edge server 1 is connected to a sensor A, a sensor B, a sensor C, and a sensor D. Then the storage unit of the edge server 1 stores a control program that performs a computation process on the sensing information. The edge server 1 can update the control program stored in the storage unit online. In addition, by inserting a USB memory into the edge server 1, the control program can be updated. A user A uses sensing information from the sensor A, the sensor B, and the sensor D. A user B uses sensing information from the sensor B, the sensor C, and the sensor D.

Update information for the control program of the user A is input from the terminal. Then, the storage unit of the edge device 1 updates the control program for the user A.

The sensing information from the sensor A, the sensor B, the sensor C, and the sensor D is input to the edge device 1. The edge device then reads the control program for the user A from the storage unit, reads the sensing information of the sensor A, the sensor B, and the sensor D from the storage unit, and causes the computation unit to perform a computation process for the user A. At this time, the information obtained as a result of the computation may undergo an encryption process for the user A. In addition, the storage unit stores identification information of an edge server (or cloud server) for transmitting information for the user A. Therefore, the edge device 1 transmits the sensing information after the computation process together with the identification information of the user A to the appropriate edge server. Regarding the user B, a control program related to a computation process different from that for the user A is stored in the storage unit. Therefore, the sensing information for the user B undergoes a different computation process from the sensing information for the user A, and the sensing information after the computation is transmitted to the appropriate edge server. In this way, the sensing information is sent only to the appropriate edge server, which eliminates the need to transmit information to a plurality of edge servers, making communication traffic less likely to become congested. Moreover, the information is sent from the edge device to the edge server after an appropriate computation process has been performed, and thus the amount of information transmitted from the edge device to the edge server can be reduced. The sensing information transmitted to the edge server is transmitted to the appropriate cloud server and utilized.

On the other hand, alert conditions are stored in the storage unit of the edge device. The alert condition may be a condition unrelated to the condition required by the user. For example, it is assumed that the edge device 1 is an in-vehicle device and the sensor A is a concentration meter that measures carbon monoxide concentration within a company. Then, the edge device 1 stores a threshold value of the carbon monoxide concentration in the storage unit. When the carbon monoxide concentration is input from the sensor A, the threshold value is read from the storage unit, and the computation unit is made to compare the in-house carbon monoxide concentration with the threshold value. As a result, in a case where the value of the in-vehicle carbon monoxide concentration is greater than the threshold value, the edge device reads information for outputting an alert from the storage unit and outputs the alert. The alert may be a warning from a speaker in the vehicle, or may be information necessary to identify a person or situation that outputs the alert to a server of a security company via the edge server (GPS information, identification information, mobile number, and the like of an owner of the sensor A).

### INDUSTRIAL APPLICABILITY

The present invention may be used in information and communications related industries.

### REFERENCE SIGNS LIST

1 Edge device
3 Sensing information reception unit
5 User identification information storage unit
7 User identification information addition unit
9 Sensing information transmission unit
11 Programmable computation storage unit
13 Computation processing unit
15 Alert condition storage unit
17 Alert output unit
21 Edge server
23 Edge computing system

1. An edge device (1) comprising:
a sensing information reception unit (3) configured to receive sensing information from one or a plurality of sensors;
a user identification information storage unit (5) configured to store identification information of a user that uses the sensing information;
a user identification information addition unit (7) configured to obtain user specific sensing information that is information obtained by adding identification information of a user that uses the sensing information to the sensing information; and
a sensing information transmission unit (9) configured to transmit the user specific sensing information to an edge server.

2. The edge device (1) according to claim 1, further comprising:
a programmable computation storage unit (11) configured to programmably store a computation process to be performed on the sensing information; and
a computation processing unit (13) configured to perform a computation process stored in the programmable computation storage unit (11) on the sensing information, wherein
the sensing information transmission unit (9) transmits, to the edge server, user specific sensing information after computation that is sensing information that has been subjected to a computation process by the computation processing unit (13), and the user specific sensing information after computation is information to which identification information of a user that uses the sensing information is added.

3. The edge device (1) according to claim 2, wherein
the programmable computation storage unit (11) stores a computation process for each user, the computation process being related to the identification information of the user; and
the computation processing unit (13) performs the computation process for each user on the sensing information.

4. The edge device (1) according to claim 1, wherein
the sensing information is information received from a plurality of sensors;
the programmable computation storage unit (11) stores a computation process for each sensor, the computation processes respectively corresponding to the plurality of sensors; and
the computation processing unit (13) performs the computation process for each sensor on the sensing information.

5. The edge device (1) according to claim 1, wherein
the sensing information transmission unit (9) is configured to transmit the user specific sensing information after computation to a specific edge server among a plurality of edge servers using the identification information of the user.

6. The edge device (1) according to claim 1, further comprising:
an alert condition storage unit (15) configured to store alert conditions that are conditions for issuing an alert; and
an alert output unit (17) configured to output an alert in a case where the sensing information satisfies the alert condition.

7. An edge computing system (23) comprising the edge device (1) according to claim 1, and an edge server (21) capable of exchanging information with the edge device (1).

8. An information processing method by an edge device (1), comprising:
a sensing information reception step of receiving sensing information from one or a plurality of sensors;
a user identification information addition step of obtaining user specific sensing information that is obtained by adding identification information of a user that uses the sensing information to the sensing information; and
a sensing information transmission step of transmitting the user specific sensing information to an edge server.

9. The method according to claim 8, further comprising a step, by the edge device (1), of:
programmably storing a computation process to be performed on the sensing information; and
performing the programmably stored computation process on the sensing information; and
the sensing information transmission step
is a step of transmitting user specific sensing information after computation to the edge server, the user specific sensing information after computation being sensing information that has been subjected to the computation process and to which identification information of the user that uses the sensing information is added.

10. A program that causes an edge device (1) including a computer to function as an edge device (1), comprising:
a sensing information reception unit (3) configured to receive sensing information from one or a plurality of sensors;
a user identification information storage unit (5) configured to store identification information of a user that uses the sensing information;
a user identification information addition unit (7) configured to obtain, from the user identification information storage unit (5), user specific sensing information that is information obtained by adding identification information of a user that uses the sensing information to the sensing information; and
a sensing information transmission unit (9) configured to transmit the user specific sensing information to an edge server.

11. The program according to claim 10 that causes the edge device (1), wherein the edge device (1) further includes:
a programmable computation storage unit (11) configured to programmably store a computation process to be performed on the sensing information; and
a computation processing unit (13) configured to perform a computation process stored in the programmable computation storage unit (11) on the sensing information, wherein
the sensing information transmission unit (9) transmits, to the edge server, user specific sensing information after computation that is sensing information that has been subjected to a computation process by the computation processing unit (13), and the user specific sensing information after computation is information to which identification information of a user that uses the sensing information is added.

12. A computer-readable information recording medium having recorded thereon the program according to claim 10.

13. A computer-readable information recording medium having recorded thereon the program according to claim 11.

14. An edge computing system (23) comprising the edge device (1) according to claim 2, and an edge server (21) capable of exchanging information with the edge device (1).

15. An edge computing system (23) comprising the edge device (1) according to claim 3, and an edge server (21) capable of exchanging information with the edge device (1).

16. An edge computing system (23) comprising the edge device (1) according to claim 4, and an edge server (21) capable of exchanging information with the edge device (1).

17. An edge computing system (23) comprising the edge device (1) according to claim 5, and an edge server (21) capable of exchanging information with the edge device (1).

18. An edge computing system (23) comprising the edge device (1) according to claim 6, and an edge server (21) capable of exchanging information with the edge device (1).
